(19) United States
(12) Patent Application Publication
(10) Pub. No.: US 2015/0071719 A1
(43) Pub. Date: Mar. 12, 2015

(54) FEEDING DEVICE AND MACHINE TOOL USING THE SAME

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventors: MING-LU YANG, New Taipei (TW); TIAN-EN ZHANG, Jiashan (CN); JING-SHUANG SUI, Jiashan (CN); JIA-LIAN QI, Jiashan (CN); JIAN-SHI JIA, Jiashan (CN); YANG-MAO PENG, Jiashan (CN)

(21) Appl. No.: 14/484,224

(22) Filed: Sep. 11, 2014

(30) Foreign Application Priority Data
Sep. 11, 2013 (CN) 201310409675.7

(51) Int. Cl. B23B 39/14; B23B 47/34; B23B 39/16

(52) U.S. Cl. CPC B23B 39/14; B23B 39/161; B23B 47/34; B23B 2250/04; B23B 2270/62
USPC 408/53; 408/131; 408/56; 408/88

(57) ABSTRACT

A feeding device includes a sliding member, a saddle slidably assembled with the sliding member, a driving module for moving the saddle back and forth relative to the sliding member, a main shaft positioned on the saddle, a cutter positioned with the main shaft, at least one balancing cylinder fixedly coupled with the sliding member and the saddle for balancing the main shaft. The disclosure also supplies a machine tool using the feeding device.

### FIELD

The subject matter herein generally relates to a machine apparatus, and particularly to a feeding device and a machine tool using the same.

### BACKGROUND

Machine tool is used for machining workpieces. A common machine tool includes a machine bed, a feeding device positioned on the machine bed, and a cutter positioned on the feeding device. The feeding device moves the cutter.

### BRIEF DESCRIPTION OF THE DRAWINGS

Implementations of the present technology will now be described, by way of example only, with reference to the attached figures.

FIG. 1 illustrates an assembled, isometric view of one embodiment of a machine tool including a feeding device.

FIG. 2 illustrates an exploded, partial view of the machine tool of FIG. 1.

FIG. 3 illustrates an exploded, isometric view of the feeding device of FIG. 1.

FIG. 4 is similar to FIG. 3, but viewed from another angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A feeding device can include a sliding member, a saddle slidably assembled with the sliding member, a driving module for moving the saddle back and forth relative to the sliding member, a main shaft positioned on the saddle, a cutter positioned with the main shaft, at least one balancing cylinder fixedly coupled with the sliding member and the saddle for balancing the main shaft.

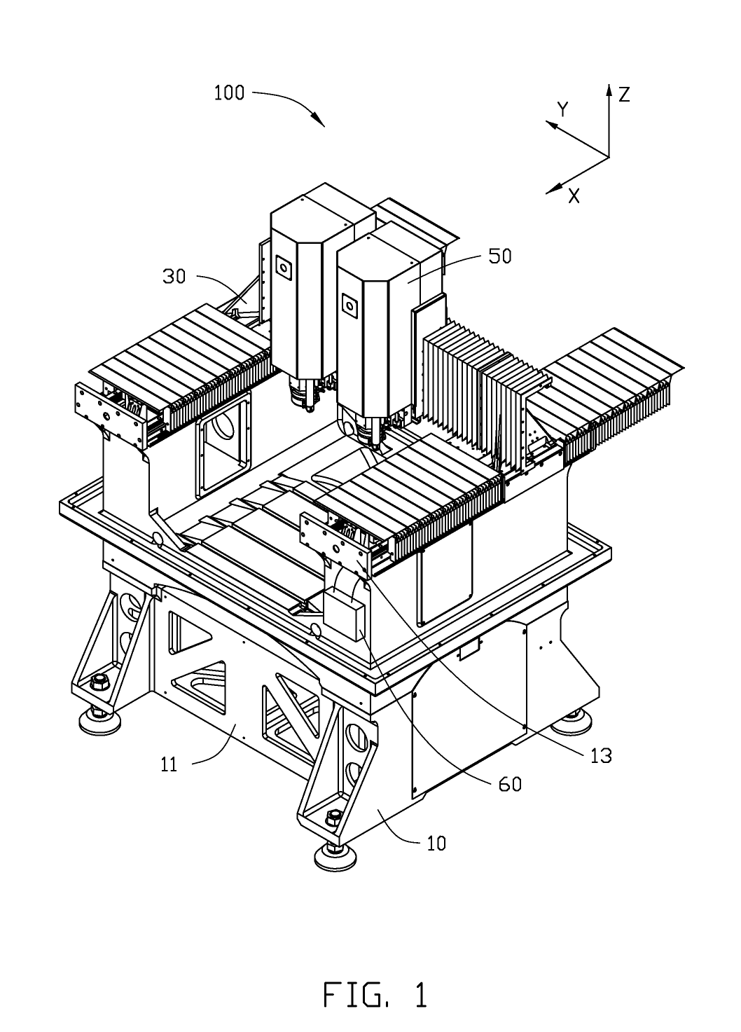

FIG. 1 illustrates a machine tool 100 of one embodiment for machining micro holes in arrays. The machine tool 100 can include a machine bed 10, a moving device 30, two feeding devices 50, and a controller 60. The moving device 30 can be movably positioned on the machine bed 10 along a first direction X. The two feeding devices 50 can be slidably arranged on the moving device 30 along a second direction Y substantially perpendicular to the first direction X. Each feeding device 50 can feed back and forth at high speed along a third direction Z perpendicular to the first direction X and the second direction Y. The controller 60 positioned on the machine bed 10 can be used for controlling the moving device 30 and the two feeding devices 50. In the illustrated embodiment, the machine tool 100 is a two-axis machine tool including two feeding devices 50 and can be used for machining holes of a speaker (not shown); the machine tool 100 can machine 20 holes in one second, a diameter of each hole is about 0.1 mm.

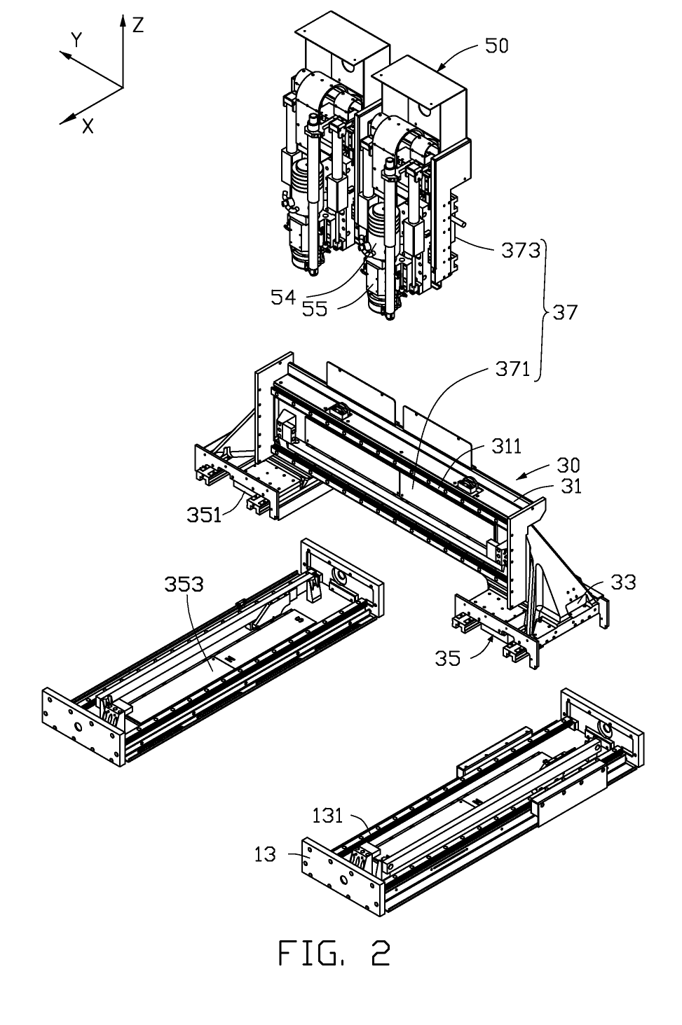

The machine bed 10 can include a base 11 and two support bodies 13 positioned on the base 11. The two support bodies 13 are substantially in parallel. Also referring to FIG. 2, two first sliding rails 131 can be separately positioned on each support body 13 away from the base 11. Each first sliding rail 131 can extend along a direction substantially parallel to the first direction X.

The moving device 30 can be substantially slidably engaged with the two support bodies 13. The moving device 30 can include a cross beam 31, two sliding seats 33, two first driving assemblies 35, and two second driving assemblies 37. The cross beam 31 can be substantially perpendicularly coupled to the two support bodies 13 and extend along the second direction Y. Two second sliding rails 311 can be formed on the cross beam 31 in parallel and extend along the second direction Y. The two sliding seats 33 can be positioned at opposite ends of the cross beam 31, respectively. Each sliding seat 33 can slidably engaging with the pair of first sliding rails 131 of one support body 13. Each first driving assembly 35 can be positioned between one sliding seat 33 and corresponding support body 13 for moving the cross beam 31 along the first direction X. The first driving assembly 35 can include a forcer 351 and a stator 353. The forcer 351 of the first driving assembly 35 can be mounted on a side surface of the sliding seat 33 away from the cross beam 31. The stator 353 of the first driving assembly 35 can be positioned on the support body 13 between the two first sliding rails 131.

Each second driving assembly 37 can include a stator 371 and a forcer 373. The stator 371 of each second driving assembly 37 can be positioned on the cross beam 31. Stators 371 of the two second driving assemblies 37 can be arranged in line along an extension direction of the cross beam 31. The forcer 373 of each second driving assembly 37 can be positioned on one feeding device 50. Each second driving assembly 37 can move corresponding feeding device 50 along the second direction Y relative to the cross beam. The first driving assembly 35 and the second driving assembly 37 can be controlled by the controller 60. In the illustrated embodiment, both the first driving assembly 35 and the second driving assembly 37 are linear motors. In at least one embodiment, the numbers of first driving assembly 35 and the second driving assembly 37 can be positioned as real application. The numbers of the forcer and stator of the first driving assembly 35 or the second driving assembly 37 are not limited, it can be also changed according to real application.

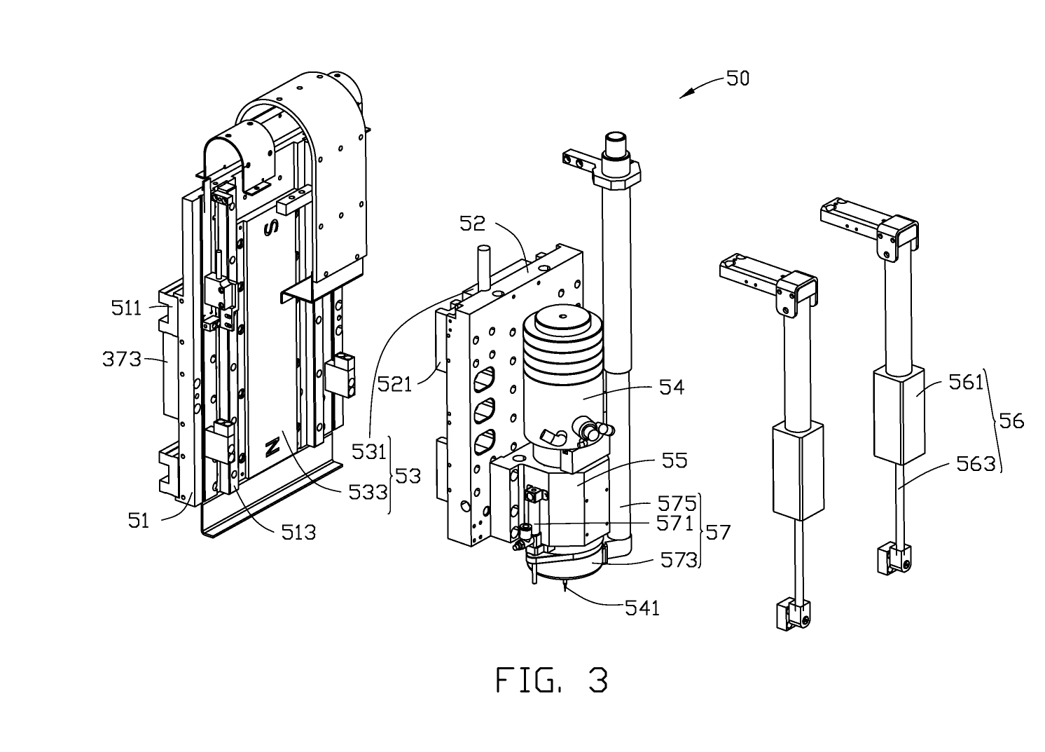

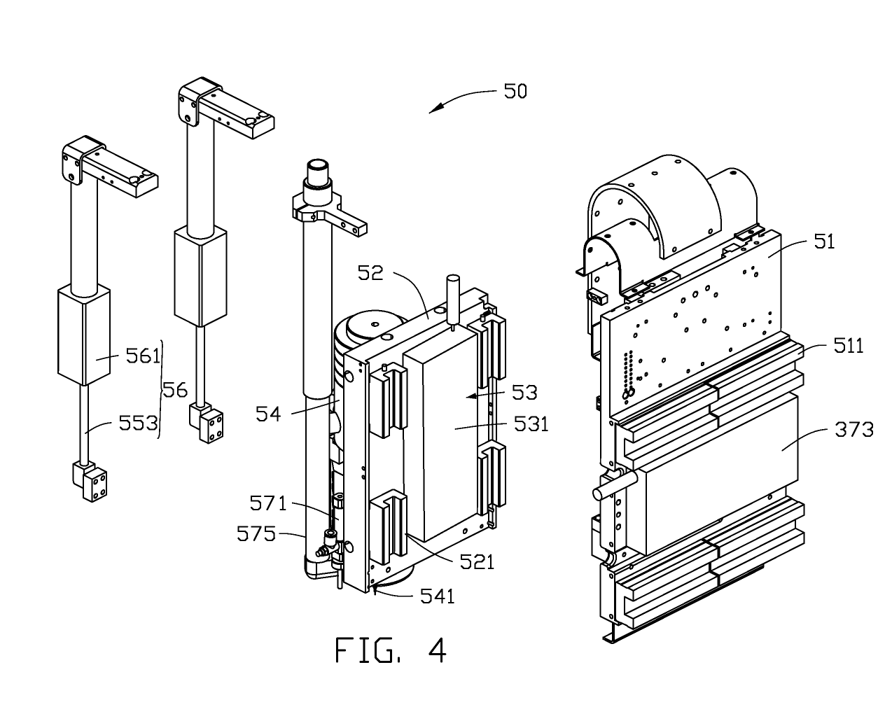

Referring to FIGS. 3 and 4, each feeding device 50 can include a sliding member 51, a saddle 52, a driving module 53, a main shaft 54, a holding member 55, and two balancing cylinders 56. The sliding member 51 can be substantially a board. The sliding member 51 can be slidably engaged with the cross beam 31. Two guiding rails 511 can be positioned on a sidewall of the sliding member 51 and extend along a direction parallel with the second direction Y. Each first guiding rail 511 can engage with corresponding one second sliding rail 311. Two slidable rails 513 can be separately positioned on another sidewall of the sliding member 51 opposite to the two first guiding rails 511 and extend along the third direction Z. The forcer 373 of the second driving module 37 can be positioned on the sliding member 31 between the two guiding rails 511. The saddle 52 can be slidably assembled with the sliding member 51.

Two groups of guide blocks 521 can be separately positioned on the saddle 52 towards the sliding member 51 and extend along the third direction Z. Each group of guide block 521 can include two guide blocks 521 arranged in line. Each group of guide block 521 can be slidably engaged with corresponding slidable rail 513, such that the saddle 52 can move along the third direction Z. The driving module 53 can be sandwiched between the sliding member 51 and the saddle 52. The driving module 53 can be capable of moving the saddle 52 back and forth along the third direction Z relative to the sliding member 51. In the illustrated embodiment, the driving module 53 can be a linear module. The driving module 53 can include a forcer 531 and a stator 533. The forcer 531 of the driving module 53 can be mounted on the saddle 52 between the two groups of guide blocks 521, the stator 533 of the driving module 53 can be positioned on the sliding member 51 between the two slidable rails 513. Interactions between magnetic fields produced by the stators 533 and the alternating magnetic fields which are produced by the forcers 531 drive the saddle into a reciprocating motion at high speed along the third direction Z.

The holding member 55 can be positioned on a side of the saddle 52 away from the sliding member 51. The main shaft 54 can be positioned on the saddle 52 via the holding member 55. A cutter 541 can be located at the main shaft 54. Two balancing cylinders 56 can be fixedly coupled with the sliding member 51 and the saddle 52 for balancing the main shaft 54. The two balancing cylinders 56 can be positioned on opposite sides of the main shaft 54. Each balancing cylinder 56 can include a cylinder body 561 and a balancing rod 563 slidably coupled to the cylinder body 561. The cylinder body 561 can be fixed on the sliding member 51 with one end portion. The balancing rod 563 can extend along a direction parallel to the third direction Z. Another end portion of the balancing rod 563 can be coupled to the saddle 52 away from the cylinder body 561. In at least one embodiment, the number of the balancing rod 563 is not limited to two, it can be one, three, or more.

The feeding device 50 can further include a chip removal assembly 57 positioned on saddle 52 via the holding member 55 for removing chip generated during a machining process. The chip removal assembly 57 can include two adjusting cylinders 571, a chip removal cover 573, and a chip removal pipe 575. The two adjusting cylinders 573 are positioned on the holding member 55. The holding member 55 can be positioned between the two adjusting cylinders 573. The chip removal cover 571 can be movably sleeved on the cutter 541 and coupled to the two adjusting cylinders 57. The chip removal pipe 575 can be coupled to the chip removal cover 571 for guiding the chip out. The adjusting cylinders 573 can be used for moving the chip removal cover 571 relative to the cutter 541, such that the cutter 451 can be exposed out from the chip removal cover 571 for machining and a gap can be formed between the cutter 541 and an inner wall of the chip removal cover 571 for collecting the chip. In other embodiments, the holding member 55 can be omitted, and then the main shaft 54 and the two adjusting cylinders 573 can be directly positioned on the saddle 52.

In assembly, the two support bodies 13 can be separately positioned on the base 11. The moving device 30 can be slidably engaging with the two support bodies 13. The feeding devices 50 can be arranged on the cross beam 31. The controller 60 can be positioned on one side surface of one base 11. The controller 60 can be electrically coupled to the feeding devices 50 and the moving device 30.

In use, the adjusting cylinders 573 can move the chip removal cover 571, then the cutter 541 exposed out of the chip removal cover 571. The main shaft 54 can rotate the cutter 541. The magnet force between the forcer of the driving module 53 and the stator 533 of the driving module 53 can drive the forcer 531 of the driving module 53 and the saddle 52 move back and forth at high speed along the third direction Z. Thus, the cutter 541 can rotate when the cutter 541 moves back and forth along the third direction Z to machine micro holes. Micro holes in arrays can be machined out when the first driving assembly 35 drive the cross beam 31 move, or the second driving assembly 37 move the feeding devices 50, or both the cross beam 31 and the feeding devices 50. The balancing cylinders 56 can pull the main shaft 54 for balancing weight of the main shaft 54, thereby keeping a power of the main shaft 54 in balance.

In other embodiments, the number of the feeding device 50 is not limited to one, it can be just one, or more.

The embodiments shown and described above are only examples. Many details are often found in the art such as the other features of a circuit board. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A feeding device comprising:
a sliding member;
a saddle slidably coupled to the sliding member;
a driving module configured to translate the saddle relative to the sliding member;
a main shaft positioned on the saddle;
a cutter positioned with the main shaft; and
at least one balancing cylinder fixedly coupled with the sliding member and the saddle, the at least one balancing cylinder configured to balance the main shaft during operation of the feeding device.

2. The feeding device of claim 1, wherein a slidable rail is positioned on the sliding member, a guide block is positioned on the saddle towards the sliding member, and the guide block is slidably engaged with the slidable rail.

3. The feeding device of claim 2, wherein the driving module comprises a forcer and a stator, the forcer of the driving module is mounted on the saddle, and the stator of the driving module is positioned on the sliding member.

4. The feeding device of claim 1, wherein the feeding device further comprises a holding member positioned on a side of the saddle away from the sliding member, and the main shaft is positioned on the saddle via the holding member.

5. The feeding device of claim 1, wherein the at least one balancing cylinder comprises a cylinder body and a balancing rod slidably coupled to the cylinder body, the cylinder body is fixed on the sliding member with one end portion, another one end portion of the balancing rod is coupled to the saddle away from the cylinder body.

6. The feeding device of claim 1, wherein the number of the at least one balancing cylinder is two, the two balancing cylinders are positioned on opposite sides of the main shaft.

7. The feeding device of claim 1, wherein the feeding device further comprises a chip removal assembly positioned on the saddle, the chip removal assembly comprises:
at least one adjusting cylinder positioned on the saddle,
a chip removal cover movably sleeved on the cutter, and
a chip removal pipe coupled to the chip removal cover, wherein the at least one adjusting cylinder is coupled with the saddle and the chip removal cover for moving the chip removal cove relative to the cutter.

8. The feeding device of claim 7, wherein the number of the at least one adjusting cylinder is two, the two adjusting cylinders are positioned on opposite sides of the holding member.

9. The feeding device of claim 1, wherein the driving module is sandwiched between the sliding member and the saddle.

10. A machine tool, comprising:
a machine bed;
a moving device movably positioned on the machine bed along a first direction;
a feeding device slidably positioned on the moving device along a second direction substantially perpendicular to the first direction, comprising:
a sliding member;
a saddle slidably assembled with the a sliding member;
a driving module configured to drive the saddle move back and forth at a high speed along a third direction substantially perpendicular to the first direction and the second direction relative to the sliding member;
a main shaft positioned on the saddle;
a cutter positioned with the main shaft;
at least one balancing cylinder fixedly coupled to the sliding member and the saddle, the at least one balancing cylinder configured to balance the main shaft during operation of the feeding device ; and
a controller configured for controlling the moving device and the feeding device .

11. The machine tool of claim 10, wherein the machine bed comprises a base and two support bodies positioned on the base, a first sliding rail is positioned on each support body away from the base and extends along a first direction.

12. The machine tool of claim 11, wherein the moving device comprises a cross beam, two sliding seats, two first driving assemblies, and a second driving assembly, the cross beam is coupled to the two support bodies, and the two sliding seats are positioned at opposite ends of the cross beam and slidably engaging with corresponding first sliding rail.

13. The machine tool of claim 12, wherein each of the two first driving assemblies comprises a forcer and a stator, the forcer of first driving assembly is positioned on one sliding seat towards the support body, and the stator of first driving assembly is positioned on the support body .

14. The machine tool of claim 12, wherein the second driving assembly comprises a forcer and a stator, the stator of the second driving assembly is positioned on the cross beam, the forcer of the second driving assembly is positioned on the sliding member.

15. The machine tool of claim 12, wherein a second sliding rail is formed on the cross beam and extends along the second direction, a guiding rail is formed on the sliding member and is slidably engaged with the second sliding rail.

16. The machine tool of claim 10, wherein a slidable rail is positioned on the sliding member, a guide block positioned on the saddle towards the sliding member, and the guide block is slidably engaged with the slidable rail.

17. The machine tool of claim 10, wherein the driving module comprises a forcer and a stator, the forcer of the driving module is mounted on the saddle, and the stator of the driving module is positioned on the sliding member.

18. The machine tool of claim 10, wherein the at least one balancing cylinder comprises a cylinder body and a balancing rod slidably coupled to the cylinder body, the cylinder body is fixed on the sliding member with one end portion, another one end portion of the balancing rod is coupled to the saddle away from the cylinder body.

19. The machine tool of claim 10, wherein the feeding device further comprises a chip removal assembly positioned on the saddle, the chip removal assembly comprises at least one adjusting cylinder positioned on the saddle, a chip removal cover movably sleeving on the cutter, and a chip removal pipe coupled to the chip removal cover, the at least one adjusting cylinder is coupled with the saddle and the chip removal cover for moving the chip removal cover relative to the cutter.

20. A two-axis machine tool, comprising:
a machine bed;
a moving device movably positioned on the machine bed;
two feeding devices separately and slidably arranged on the moving device, comprising:
a sliding member;
a saddle slidably assembled with the a sliding member;
a driving module sandwiched between the saddle and the sliding member, the driving module configured to drive the saddle undergo a reciprocating motion relative to the sliding member;
a main shaft positioned on the saddle;
a cutter positioned with the main shaft; and
at least one balancing cylinder fixedly coupled to the sliding member and the saddle, the at least one balancing cylinder configured to balance the main shaft.
a controller configured for controlling the moving device and the two feeding device.
